(19) United States
(12) Patent Application Publication
(10) Pub. No.: US 2013/0216392 A1
(43) Pub. Date: Aug. 22, 2013

(54) WIND TURBINE, ROTOR BLADE, AND OBSTRUCTION REMOVAL SYSTEM FOR ROTOR BLADE

(71) Applicants: Jingyun Xia, Shanghai (CN); Meng Gao, Shanghai (CN); Tiantian Tang, Shanghai (CN); Hui Hao, Shanghai (CN)

(72) Inventors: Jingyun Xia, Shanghai (CN); Meng Gao, Shanghai (CN); Tiantian Tang, Shanghai (CN); Hui Hao, Shanghai (CN)

(73) Assignee: General Electric Company, Schenectady, NY (US)

(21) Appl. No.: 13/883,095

(22) PCT Filed: Nov. 5, 2010
(86) PCT No.: PCT/CN2010/001776

§ 371 Date: May 2, 2013

(51) Int. Cl. F03D 11/00

(52) U.S. Cl. CPC F03D 11/00
USPC 416/241 R

(57) ABSTRACT

A wind turbine blade (112) is situated on a wind turbine (100). The wind turbine blade (112) includes a tip portion (122) and an obstruction removal system (200). The tip 212 portion (122) comprises an end wall which defines an opening. The obstruction removal system (200) is positioned with respect to the blade (112) so as to remove obstructions from the opening.

### BACKGROUND OF THE INVENTION

The subject matter described herein relates generally to wind turbines and, more particularly, to a wind turbine, a rotor blade, and an obstruction removal system for a rotor blade.

Generally, a wind turbine includes a rotor that includes a rotatable hub assembly having multiple rotor blades. The rotor blades transform wind energy into a mechanical rotational torque that drives one or more generators via the rotor. The generators are sometimes, but not always, rotationally coupled to the rotor through a gearbox. The gearbox steps up the inherently low rotational speed of the rotor for the generator to efficiently convert the rotational mechanical energy to electrical energy, which is fed into a utility grid via at least one electrical connection. Gearless direct drive wind turbines also exist. The rotor, generator, gearbox and other components are typically mounted within a housing, or nacelle, that is positioned on top of a tower.

During operation of a wind turbine, humidity within ambient air may condense within one or more rotor blades. Such condensation may damage the rotor blades. For example, if lightning strikes a rotor blade, condensation within the rotor blade may vaporize and cause a sudden increase in pressure within the blade such that the blade may crack or fail. Accordingly, at least some known rotor blades include a drain opening within a tip portion of each rotor blade. Condensation and/or other fluids may be removed from the rotor blades through such drain openings by gravity and/or by a centrifugal force generated by a rotation of the rotor blades. However, during operation of the wind turbine, one or more drain openings may become obstructed due to an accumulation of particulates proximate to and/or within the drain openings. Such obstructions may reduce an effectiveness of the drain openings in removing condensation or other fluids from the rotor blades.

### BRIEF DESCRIPTION OF THE INVENTION

In one embodiment, a rotor blade for a wind turbine is provided that includes a tip portion including an end wall defining an opening. An obstruction removal system is positioned with respect to the rotor blade and the obstruction removal system is configured to remove obstructions from the opening.

In another embodiment, an obstruction removal system is provided for use in a wind turbine rotor blade having an opening defined in an end wall. The obstruction removal system includes a movable component and a pin coupled to the movable component. The movable component is configured to position the pin in the opening to remove obstructions from the opening.

In yet another embodiment, a wind turbine is provided that includes a rotor blade configured to rotate about an axis. The rotor blade includes a tip portion that includes an end wall having an opening defined therein. The wind turbine also includes an obstruction removal system positioned with respect to the rotor blade that is configured to remove obstructions from the opening.

### BRIEF DESCRIPTION OF THE DRAWINGS

FIG. 1 is a perspective view of an exemplary wind turbine.

FIG. 2 is a partial sectional view of an exemplary nacelle suitable for use with the wind turbine shown in FIG. 1.

FIG. 3 is a cross-sectional view of an exemplary obstruction removal system in a retracted position suitable for use with the wind turbine shown in FIG. 1.

FIG. 4 is a cross-sectional view of the exemplary obstruction removal system in an extended position shown in FIG. 3.

FIG. 5 is a cross-sectional view of a rotor blade including an alternative obstruction removal system suitable for use with the wind turbine shown in FIG. 1.

FIG. 6 is a cross-sectional view of a portion of the alternative obstruction removal system shown in FIG. 5.

FIG. 7 is a cross-sectional view of another alternative obstruction removal system suitable for use with the wind turbine shown in FIG. 1.

FIG. 8 is a cross-sectional view of yet another alternative obstruction removal system suitable for use with the wind turbine shown in FIG. 1.

### DETAILED DESCRIPTION OF THE INVENTION

The embodiments described herein provide obstruction removal systems for use with a wind turbine rotor blade. In one embodiment, the obstruction removal system includes a rotatable component coupled to a pin. When gravity and/or a centrifugal force generated by a rotation of the rotor blade acts on the rotatable component, the pin is displaced into and/or through an opening defined in an end wall of a rotor blade tip portion. In another embodiment, the obstruction removal system includes a cable that is coupled to an extension device. When an activation device is operated, the cable is retracted to operate the extension device. A pin within the extension device is displaced into and/or through the opening in the end wall. In another embodiment, the obstruction removal system includes a mass that pivots about a fulcrum when gravity and/or a centrifugal force generated by the rotation of the rotor blade acts upon the mass. When the mass pivots, a pin is displaced into and/or through the opening in the end wall. In yet another embodiment, a motor extends and retracts a pin into and out of the opening in the end wall. As such, the embodiments described herein facilitate using an obstruction removal system to displace a pin into and/or through the opening to dislodge and/or remove particulates or other obstructions from the opening. Moreover, the obstruction removal systems described herein do not require electricity to operate, thus simplifying a construction, an operation, and/or a configuration of the wind turbine, the rotor blades, and/or the obstruction removal systems.

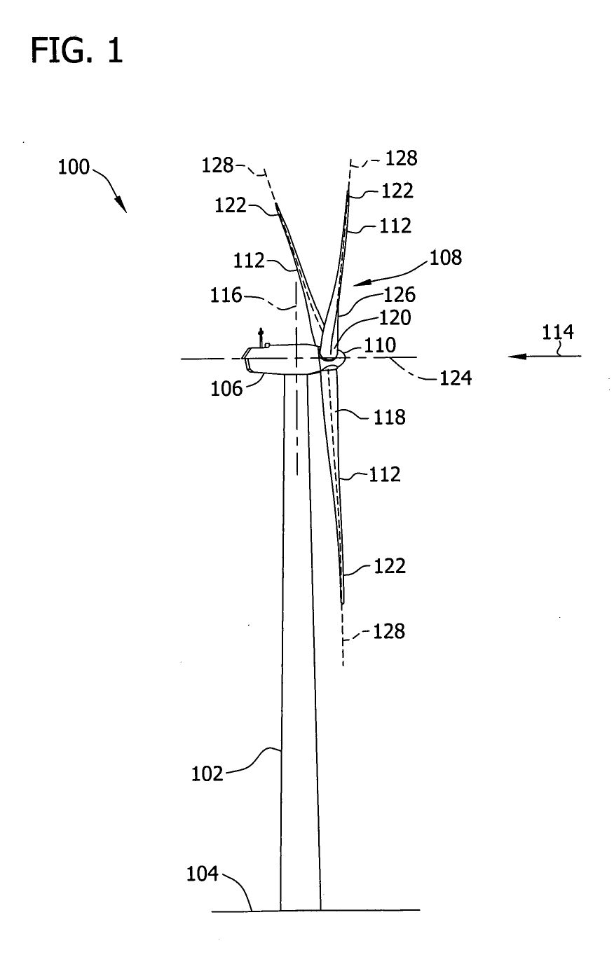

FIG. 1 is a schematic view of an exemplary wind turbine 100. In the exemplary embodiment, wind turbine 100 is a horizontal-axis wind turbine. Alternatively, wind turbine 100 may be a vertical-axis wind turbine. In the exemplary embodiment, wind turbine 100 includes a tower 102 extending from and coupled to a supporting surface 104. Tower 102 may be coupled to surface 104 with anchor bolts or via a foundation mounting piece (neither shown), for example. A nacelle 106 is coupled to tower 102, and a rotor 108 is coupled to nacelle 106. Rotor 108 includes a rotatable hub 110 and a plurality of rotor blades 112 coupled to hub 110. In the exemplary embodiment, rotor 108 includes three rotor blades 112. Alternatively, rotor 108 may have any suitable number of rotor blades 112 that enables wind turbine 100 to function as described herein. Tower 102 may have any suitable height and/or construction that enables wind turbine 100 to function as described herein.

Rotor blades 112 are spaced about hub 110 to facilitate rotating rotor 108, thereby transferring kinetic energy from wind 114 into usable mechanical energy, and subsequently, electrical energy. Rotor 108 and nacelle 106 are rotated about tower 102 on a yaw axis 116 to control a perspective of rotor blades 112 with respect to a direction of wind 114. Rotor blades 112 are mated to hub 110 by coupling a rotor blade root portion 118 to hub 110 at a plurality of load transfer regions 120. Load transfer regions 120 each have a hub load transfer region and a rotor blade load transfer region (both not shown in FIG. 1). Loads induced to rotor blades 112 are transferred to hub 110 via load transfer regions 120. Each rotor blade 112 also includes a rotor blade tip portion 122.

In the exemplary embodiment, rotor blades 112 have a length of between approximately 30 meters (m) (99 feet (ft)) and approximately 120 m (394 ft). Alternatively, rotor blades 112 may have any suitable length that enables wind turbine 100 to function as described herein. For example, rotor blades 112 may have a suitable length less than 30 m or greater than 120 m. As wind 114 contacts rotor blade 112, lift forces are induced to rotor blade 112 and rotation of rotor 108 about an axis of rotation 124 is induced as rotor blade tip portion 122 is accelerated.

A pitch angle (not shown) of rotor blades 112, i.e., an angle that determines the perspective of rotor blade 112 with respect to the direction of wind 114, may be changed by a pitch assembly (not shown in FIG. 1). More specifically, increasing a pitch angle of rotor blade 112 decreases an amount of rotor blade surface area 126 exposed to wind 114 and, conversely, decreasing a pitch angle of rotor blade 112 increases an amount of rotor blade surface area 126 exposed to wind 114. The pitch angles of rotor blades 112 are adjusted about a pitch axis 128 at each rotor blade 112.

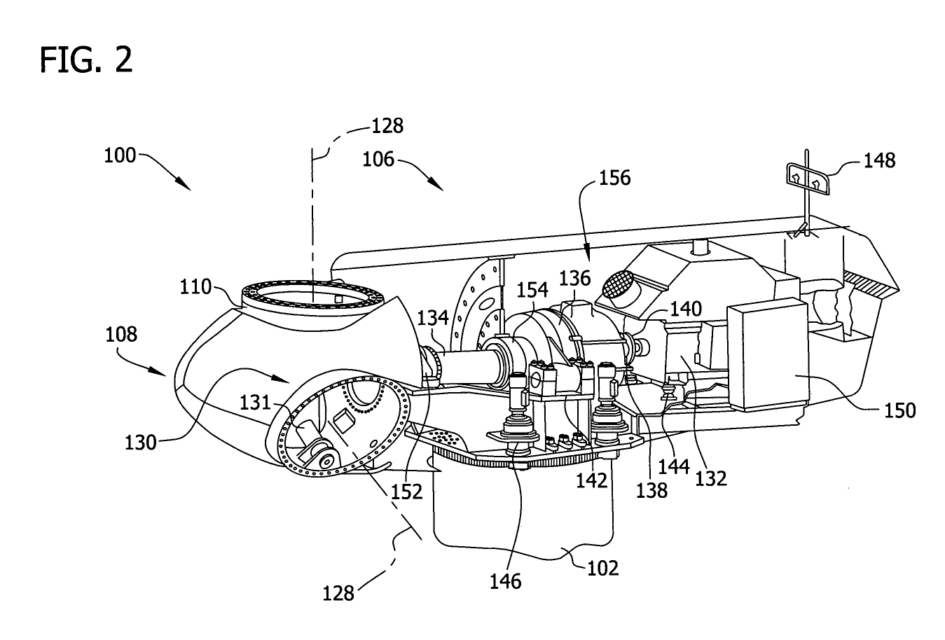

FIG. 2 is a partial sectional view of nacelle 106 of exemplary wind turbine 100 (shown in FIG. 1). Various components of wind turbine 100 are housed in nacelle 106. In the exemplary embodiment, nacelle 106 includes three pitch assemblies 130. Each pitch assembly 130 is coupled to an associated rotor blade 112 (shown in FIG. 1), and modulates a pitch of an associated rotor blade 112 about pitch axis 128. Only one of three pitch assemblies 130 is shown in FIG. 2. In the exemplary embodiment, each pitch assembly 130 includes at least one pitch drive motor 131.

As shown in FIG. 2, rotor 108 is rotatably coupled to an electric generator 132 positioned within nacelle 106 via a rotor shaft 134 (sometimes referred to as either a main shaft or a low speed shaft), a gearbox 136, a high speed shaft 138, and a coupling 140. Rotation of rotor shaft 134 rotatably drives gearbox 136 that subsequently drives high speed shaft 138. High speed shaft 138 rotatably drives generator 132 via coupling 140 and rotation of high speed shaft 138 facilitates production of electrical power by generator 132. Gearbox 136 is supported by a support 142 and generator 132 is supported by a support 144. In the exemplary embodiment, gearbox 136 utilizes a dual path geometry to drive high speed shaft 138. Alternatively, rotor shaft 134 is coupled directly to generator 132 via coupling 140.

Nacelle 106 also includes a yaw drive mechanism 146 that rotates nacelle 106 and rotor 108 about yaw axis 116 (shown in FIG. 1) to control the perspective of rotor blades 112 with respect to the direction of wind 114. Nacelle 106 also includes at least one wind measuring device 148 that includes a wind vane and anemometer (neither shown in FIG. 2). In one embodiment, wind measuring device 148 provides information, including wind direction and/or wind speed, to a turbine control system 150. Turbine control system 150 includes one or more controllers or other processors configured to execute control algorithms. As used herein, the term “processor” includes any programmable system including systems and microcontrollers, reduced instruction set circuits (RISC), application specific integrated circuits (ASIC), programmable logic circuits (PLC), and any other circuit capable of executing the functions described herein. The above examples are exemplary only, and thus are not intended to limit in any way the definition and/or meaning of the term processor. Moreover, turbine control system 150 may execute a SCADA (Supervisory, Control and Data Acquisition) program.

Pitch assembly 130 is operatively coupled to turbine control system 150. In the exemplary embodiment, nacelle 106 also includes forward support bearing 152 and aft support bearing 154. Forward support bearing 152 and aft support bearing 154 facilitate radial support and alignment of rotor shaft 134. Forward support bearing 152 is coupled to rotor shaft 134 near hub 110. Aft support bearing 154 is positioned on rotor shaft 134 near gearbox 136 and/or generator 132. Nacelle 106 may include any number of support bearings that enable wind turbine 100 to function as disclosed herein. Rotor shaft 134, generator 132, gearbox 136, high speed shaft 138, coupling 140, and any associated fastening, support, and/or securing device including, but not limited to, support 142, support 144, forward support bearing 152, and aft support bearing 154, are sometimes referred to as a drive train 156.

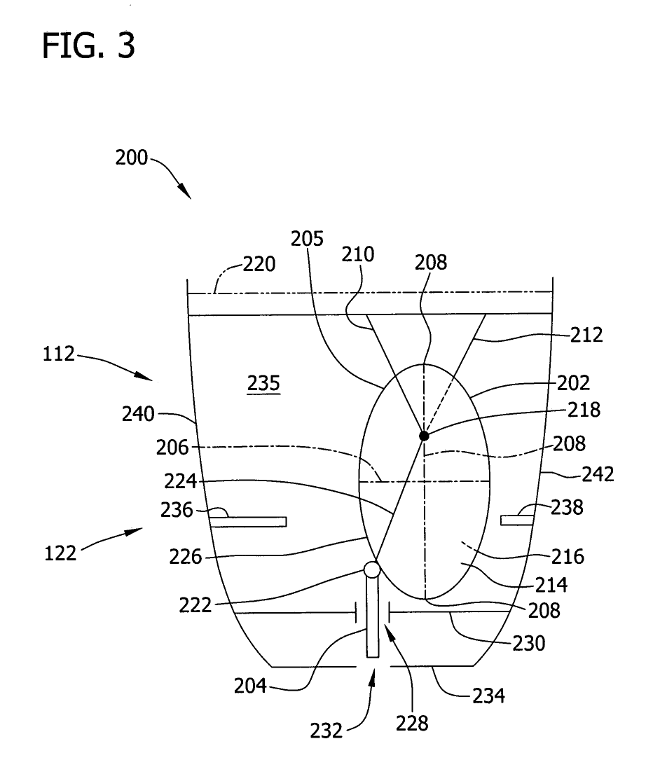

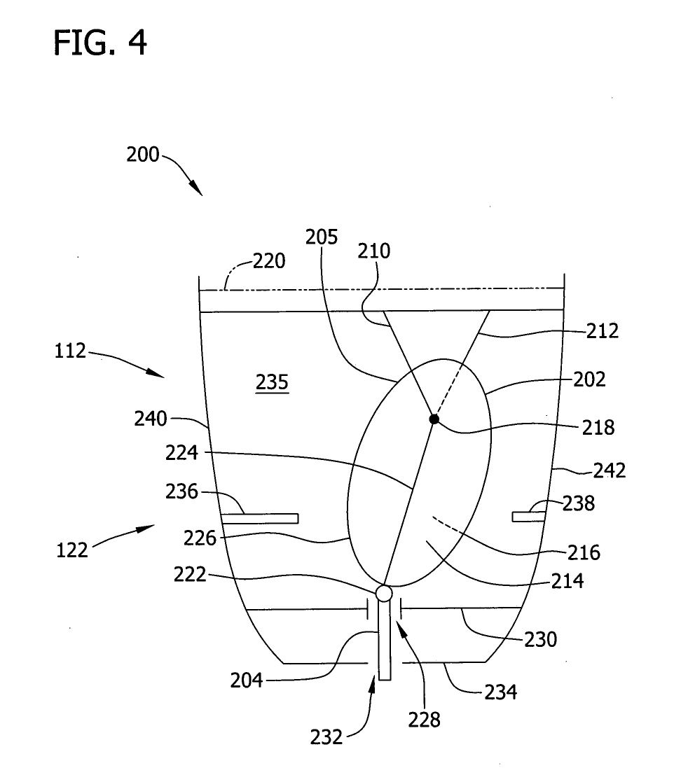

FIG. 3 is a cross-sectional view of an exemplary obstruction removal system 200 in a retracted position suitable for use with wind turbine 100 (shown in FIG. 1). FIG. 4 is a cross-sectional view of obstruction removal system 200 in an extended position. In the exemplary embodiment, obstruction removal system 200 is positioned within rotor blade tip portion 122. Alternatively, obstruction removal system 200 is positioned within any suitable component and/or system of rotor blade 112 and/or any suitable component and/or system of wind turbine 100 associated with rotor blade 112.

In the exemplary embodiment, obstruction removal system 200 includes a rotatable component 202 and a pin 204 that is operatively coupled to, such as positioned in contact with rotatable component 202. In the exemplary embodiment, rotatable component 202 is a cam 205 that has a width 206 that is smaller than a height 208. Alternatively, rotatable component 202 may be any suitable component that enables obstruction removal system 200 to operate as described herein. In the exemplary embodiment, rotatable component 202 is coupled to rotor blade tip portion 122 by a first support 210 and a second support 212. Rotatable component 202 includes a first surface 214, an opposing second surface 216, and a pivot axis 218 that extends between first surface 214 and second surface 216. First support 210 is coupled to first surface 214 at pivot axis 218, and second support 212 is coupled to second surface 216 at pivot axis 218. Moreover, in the exemplary embodiment, pivot axis 218 is substantially perpendicular to pitch axis 128 (shown in FIG. 1) and is substantially perpendicular to a chord line 220 of rotor blade 112. Alternatively, rotatable component 202 may have any suitable configuration that enables obstruction removal system 200 to operate as described herein.

In the exemplary embodiment, pin 204 includes a head portion 222 that is coupled to pivot axis 218 by a spring 224 that biases head portion 222 against a perimeter 226 of rotatable component 202. Alternatively, pin 204 and/or head portion 222 are biased against and/or coupled to rotatable component 202 by any other suitable component or device. In the exemplary embodiment, pin 204 is positioned at least partially within an opening 228 defined in a guide wall 230. Moreover, guide wall 230 limits a radial movement of pin 204 such that pin 204 is directed towards and/or through an opening 232 defined in a rotor blade end wall 234 during operation of wind turbine 100. Opening 232, in the exemplary embodiment, is in flow communication with an external environment outside rotor blade 112 and with a cavity 235 defined within rotor blade 112 to facilitate draining and/or removing fluid and/or particulates from within cavity 235. As used herein, the term “radial” refers to a direction substantially parallel to chord line 220 and substantially perpendicular to pitch axis 128.

Moreover, in the exemplary embodiment, a first radial stop 236 and/or a second radial stop 238 are coupled to rotor blade tip portion 112 to limit a rotation of rotatable component 202. More specifically, first radial stop 236 and/or second radial stop 238 may be manufactured from any suitable material that prevents rotatable component 202 from contacting a leading edge 240 and/or a trailing edge 242 of rotor blade 112.

During operation of wind turbine 100, obstruction removal system 200 may alternate between a retracted position (shown in FIG. 3) and an extended position (shown in FIG. 4). In the retracted position, pin 204 is maintained in contact with perimeter 226 of rotatable component 202 by spring 224 such that pin 204 does not extend through opening 232 of rotor blade end wall 234. As rotor blade 112 rotates about axis of rotation 124 (shown in FIG. 1), gravity and/or a centrifugal force generated by the rotation of rotor blade 112 may cause rotatable component 202 to rotate about pivot axis 218. As rotatable component 202 rotates, perimeter 226 displaces pin 204 into and/or through opening 232 as pin 204 moves along perimeter 226 to a position of maximum height 208 of rotatable component 202. Guide wall 230 prevents pin 204 from moving radially such that pin 204 is substantially displaced through opening 232 rather than allowing pin 204 to rotate with rotatable component 202. Accordingly, if particulates and/or other obstructions have accumulated within and/or proximate to opening 232, pin 204 facilitates dislodging the particulates and/or obstructions as pin 204 is displaced into and/or through opening 232. As such, obstruction removal system 200 facilitates maintaining a substantially unobstructed opening 232 within rotor blade end wall 234, without the use of electrically-driven components, such that condensation and/or any other fluid may drain from rotor blade 112 through opening 232.

Moreover, as rotor blade 112 rotates about axis of rotation 124, a force and/or a direction of gravity and/or of the centrifugal force may vary. Accordingly, rotatable component 202 may rotate back to the retracted position shown in FIG. 3, such that spring 224 retracts pin 204 back into rotor blade 112 and away from opening 232.

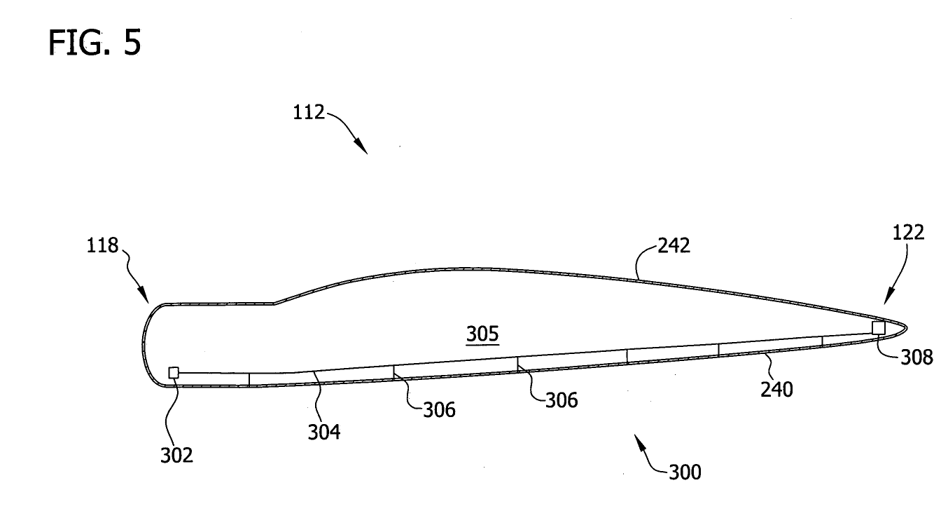

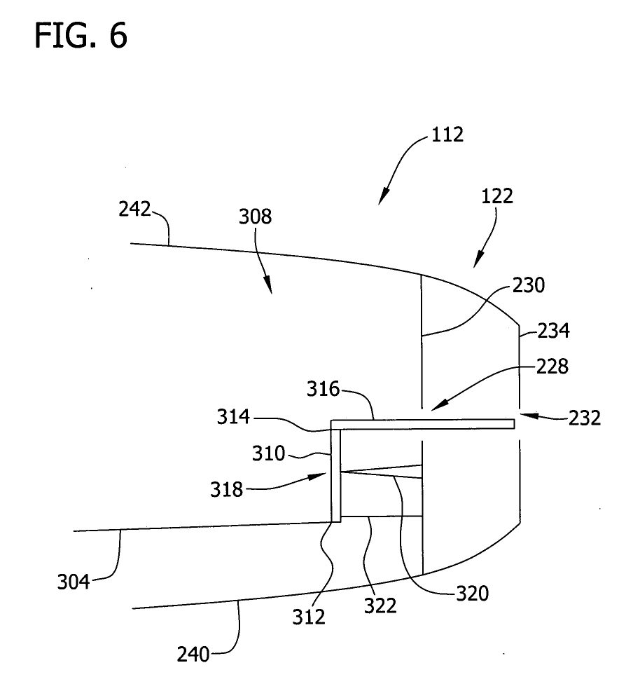

FIG. 5 is a cross-sectional view of rotor blade 112 that includes an alternative obstruction removal system 300 suitable for use with wind turbine 100 (shown in FIG. 1). FIG. 6 is a cross-sectional view of rotor blade tip portion 122 that includes a portion of obstruction removal system 300. Components shown in FIGS. 5 and 6 that are similar to components in FIGS. 3 and 4 are labeled with the same reference numerals. In the exemplary embodiment, obstruction removal system 300 is positioned at least partially within rotor blade 112. Alternatively, obstruction removal system 300 is positioned within any suitable component and/or system of wind turbine 100 associated with rotor blade 112.

In the exemplary embodiment, obstruction removal system 300 includes an activation device 302 that is positioned within rotor blade root portion 118 and/or within hub 110 (shown in FIG. 1). Alternatively, activation device 302 may be positioned within nacelle 106 or within any suitable component of wind turbine 100 that enables obstruction removal system 300 to operate as described herein. In the exemplary embodiment, activation device 302 is coupled to a cable 304 that extends through a cavity 305 defined within rotor blade 112. Activation device 302, in the exemplary embodiment, includes a pull handle (not shown) and/or any other suitable device that may be manually activated by a user. Alternatively, activation device 302 may include a motor and/or any other suitable device that may be manually activated by a user and/or any device that may be automatically activated by turbine control system 150 (shown in FIG. 2) and/or by any other suitable system.

Cable 304 is coupled to rotor blade 112 by a plurality of coupling mechanisms 306. Coupling mechanisms 306 may include one or more rings, hoops, hooks, ties, brackets, and/or any other suitable mechanism that enables cable 304 to be coupled within rotor blade 112. In the exemplary embodiment, coupling mechanisms 306 couple cable 304 within rotor blade 112 proximate to leading edge 240. Alternatively, cable 304 may be coupled within rotor blade 112 by coupling mechanisms 306 at any suitable location.

Moreover, in the exemplary embodiment, cable 304 is coupled to an extension device 308 that is positioned within rotor blade tip portion 122. Referring further to FIG. 6, extension device 308, in the exemplary embodiment, includes a support bar 310 that is coupled to cable 304 at a first end 312. A second end 314 of support bar 310 is coupled to a pin 316. A middle portion 318 of support bar 310 is coupled to a fulcrum 320 that is coupled to guide wall 230 such that support bar 310 pivots about fulcrum 320. A spring 322 is coupled to first end 312 or proximate to first end 312 to bias extension device 308 and/or pin 316 in a retracted position. Pin 316 is positioned at least partially within opening 228 defined within guide wall 230. Moreover, extension device 308 is movable such that pin 316 may be directed towards and/or through opening 232 defined in rotor blade end wall 234.

During operation of wind turbine 100, obstruction removal system 300 is selectively movable between a retracted position (shown in FIG. 6) and an extended position (not shown). In the retracted position, support bar 310 is biased by spring 322 such that pin 316 does not extend through opening 232 of rotor blade end wall 234. A user and/or a suitable system may operate activation device 302 to move extension device 308 into an extended position to facilitate removing particulates and/or obstructions from opening 232. More specifically, activation device 302 at least partially retracts cable 304 such that cable 304 pulls first end 312 towards rotor blade root portion 118. As first end 312 is pulled towards rotor blade root portion 118, support bar 310 pivots about fulcrum 320 such that second end 314 is directed towards rotor blade end wall 234. Second end 314 displaces pin 316 into and/or through opening 232, thus facilitating dislodging one or more particulates and/or obstructions that may have accumulated within and/or proximate to opening 232. As such, obstruction removal system 300 facilitates maintaining a substantially unobstructed opening 232 within rotor blade end wall 234 such that condensation and/or any other fluid may drain from rotor blade 112 through opening 232.

To retract extension device 308 and/or pin 316, activation device 302 is operated such that activation device 302 relaxes cable 304. Spring 322 pulls first end 312 towards rotor blade end wall 234 causing support bar 310 to pivot about fulcrum 320 and retract pin 316 from opening 232.

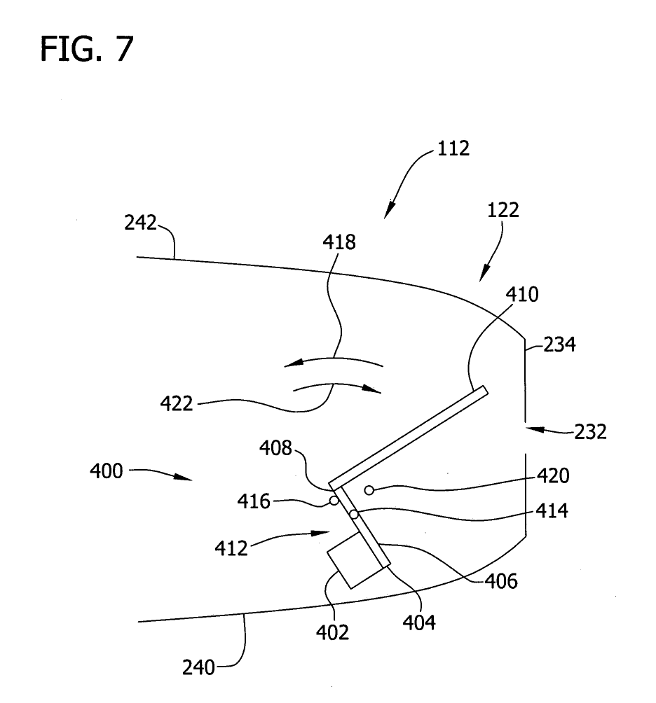

FIG. 7 is a cross-sectional view of another alternative obstruction removal system 400 suitable for use with wind turbine 100 (shown in FIG. 1). Components shown in FIG. 7 that are similar to components in FIGS. 3 and 4 are labeled with the same reference numerals. In the exemplary embodiment, obstruction removal system 400 is positioned within rotor blade tip portion 122. Alternatively, obstruction removal system 400 is positioned within any suitable component and/or system of rotor blade 112 and/or any suitable component and/or system of wind turbine 100 associated with rotor blade 112.

In the exemplary embodiment, obstruction removal system 400 includes a mass 402 that is coupled to a first or rear end 404 of a support bar 406. A second or front end 408 of support bar 406 is coupled to a pin 410. Moreover, support bar 406 is rotatably coupled at a middle portion 412 to a pivot bar 414 such that support bar 406 may pivot about pivot bar 414 during operation of wind turbine 100. A first guide post 416 is coupled to rotor blade 112 to limit a rotation of support bar 406 about pivot bar 414 in a first direction, such as a counter-clockwise direction 418. A second guide post 420 is coupled to rotor blade 112 to limit a rotation of support bar 406 about pivot bar 414 in a second direction that is opposite of first direction 418, such as in a clockwise direction 422.

During operation of wind turbine 100, obstruction removal system 400 may alternate between a retracted position (shown in FIG. 7) and an extended position (not shown). In the retracted position, support bar 406 is maintained in contact with first guide post 416 and/or at a position between first guide post 416 and second guide post 420 by gravity and/or a centrifugal force generated by a rotation of rotor blade 112. As such, pin 410 is prevented from extending through opening 232 of rotor blade end wall 234. As rotor blade 112 rotates about axis of rotation 124 (shown in FIG. 1), gravity may act upon mass 402 such that mass 402, support bar 406, and pin 410 rotate about pivot bar 414 in second direction 422 and into the extended position. More specifically, pin 410 is displaced into and/or through opening 232 as pin 410 is rotated in second direction 422. Second guide post 420 limits a displacement of pin 410 in second direction 422 after pin 410 is displaced into and/or through opening 232. Accordingly, if particulates and/or other obstructions have accumulated within and/or proximate to opening 232, pin 410 facilitates dislodging the particulates and/or obstructions as pin 410 is displaced into and/or through opening 232. As such, obstruction removal system 400 facilitates maintaining a substantially unobstructed opening 232 within rotor blade end wall 234, without the use of electrically-driven components, such that condensation and/or any other fluid may drain from rotor blade 112 through opening 232.

As rotor blade 112 continues to rotate about axis of rotation 124, a force and/or a direction of gravity and/or of the centrifugal force may vary. Accordingly, mass 402 may rotate back in first direction 418 such that support bar 406 is brought into contact with first guide post 416 and into the retracted position shown in FIG. 7. Accordingly, pin 410 may be retracted back into rotor blade 112 and away from opening 232.

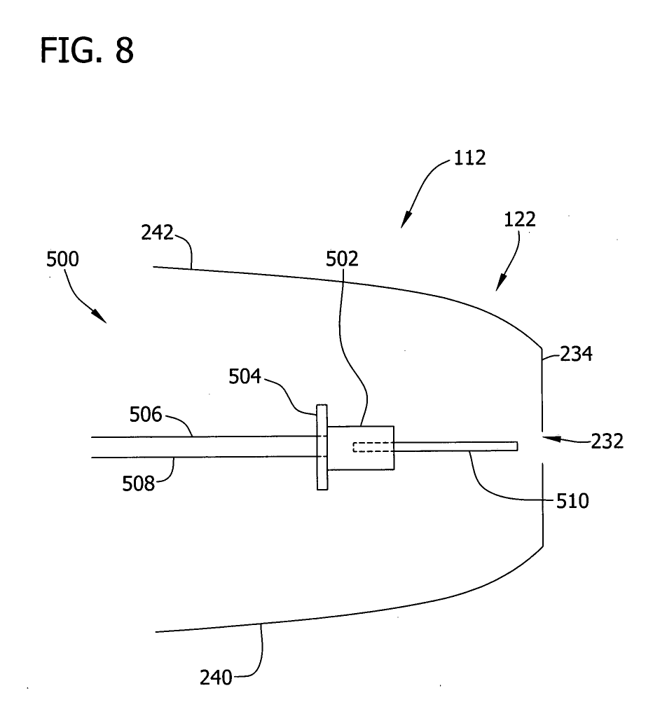

FIG. 8 is a cross-sectional view of yet another alternative obstruction removal system 500 suitable for use with wind turbine 100 (shown in FIG. 1). Components shown in FIG. 8 that are similar to components in FIGS. 3 and 4 are labeled with the same reference numerals. In the exemplary embodiment, obstruction removal system 500 is positioned within rotor blade tip portion 122. Alternatively, obstruction removal system 500 is positioned within any suitable component and/or system of rotor blade 112 and/or any suitable component and/or system of wind turbine 100 associated with rotor blade 112.

In the exemplary embodiment, obstruction removal system 500 includes a motor 502 that is coupled to a support structure 504 within rotor blade tip portion 122. Motor 502 is coupled to a control system, such as turbine control system 150 (shown in FIG. 2), by a data connection 506. Data connection 506 may be a wired data connection 506 and/or a wireless data connection 506 such that the control system may communicate with motor 502 wirelessly and/or through wired data connection 506. Moreover, motor 502 is coupled to a power source (not shown) within rotor blade 112, hub 110, nacelle 106 (shown in FIG. 1), and/or within any suitable location of wind turbine 100 by a power conduit 508. Alternatively or additionally, motor 502 may include and/or may be coupled to a battery and/or any other suitable power storage device (not shown). Support structure 504, in the exemplary embodiment, may include a wall, a bulkhead, a flange, and/or any other suitable structure that enables motor 502 to be secured within rotor blade 112 and/or within rotor blade tip portion 122.

In the exemplary embodiment, a pin 510 is coupled to and/or is at least partially positioned within motor 502. Moreover, in the exemplary embodiment, pin 510 is substantially cylindrical and is extendable into and/or through opening 232. Alternatively, pin 510 may be any suitable shape and may be coupled to a lever, a fulcrum, and/or any other suitable structure that enables obstruction removal system 500 to operate as described herein.

During operation of wind turbine 100, obstruction removal system 500 may alternate between a retracted position (shown in FIG. 8) and an extended position (not shown). In the retracted position, pin 510 is maintained at least partially within motor 502 such that pin 510 does not extend into and/or through opening 232. Upon receiving a suitable control signal from the control system, motor 502 extends pin 510 into and/or through opening 232. Accordingly, if particulates and/or other obstructions have accumulated within and/or proximate to opening 232, pin 510 facilitates dislodging the particulates and/or obstructions as pin 510 is displaced into and/or through opening 232. Motor 502 retracts pin 510 from opening 232 upon receiving a suitable control signal from the control system. Alternatively, motor 502 is not controlled by the control system. In such an embodiment, motor 502 may extend and/or retract pin 510 based on an operation of a timer (not shown) that is coupled to motor 502, and/or based on any other control circuit or device that enables obstruction removal system 500 to operate as described herein.

The above-described embodiments provide obstruction removal systems for use with a wind turbine rotor blade. More specifically, the obstruction removal systems are used to remove particulates and/or other suitable obstructions that may accumulate proximate to and/or within an opening defined in an end wall of the rotor blade. The obstruction removal systems described herein use gravity and/or a centrifugal force generated by a rotation of the rotor blade to displace a pin into and/or through the opening to dislodge and/or remove any particulates or other obstructions from the opening. Moreover, the obstruction removal systems are configured to automatically operate using gravity and/or the centrifugal force generated by the rotation of the rotor blade. As such, the obstruction removal systems described herein do not require electricity to operate, thus simplifying a construction, an operation, and/or a configuration of the wind turbine, the rotor blades, and/or the obstruction removal systems.

Exemplary embodiments of a wind turbine, a rotor blade, and an obstruction removal system for a rotor blade are described above in detail. The wind turbine, rotor blade, and obstruction removal system are not limited to the specific embodiments described herein, but rather, components of the wind turbine, rotor blade, and/or obstruction removal system may be utilized independently and separately from other components and/or steps described herein. For example, the obstruction removal system may also be used in combination with other wind turbines or wind turbine components, and is not limited to practice with only the wind turbine and rotor blade as described herein. Rather, the exemplary embodiment can be implemented and utilized in connection with many other wind turbine applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A rotor blade for a wind turbine, said rotor blade comprising:
a tip portion comprising an end wall, said end wall defining an opening; and,
an obstruction removal system positioned with respect to said rotor blade, said obstruction removal system configured to remove obstructions from the opening.

2. A rotor blade in accordance with claim 1, wherein said obstruction removal system is configured to operate by at least one of gravity and a centrifugal force generated by a rotation of said rotor blade.

3. A rotor blade in accordance with claim 1, wherein said obstruction removal system comprises a rotatable component and a pin, said rotatable component configured to position said pin in the opening to remove obstructions from the opening.

4. A rotor blade in accordance with claim 3, further comprising a spring coupling said pin to said rotatable component to facilitate retracting said pin from the opening.

5. A rotor blade in accordance with claim 3, wherein said rotatable component comprises a cam.

6. A rotor blade in accordance with claim 3, wherein a pitch axis is defined along a length of said rotor blade, said rotor blade further comprising a guide wall configured to limit a movement of said pin in a radial direction with respect to the pitch axis.

7. A rotor blade in accordance with claim 1, wherein said obstruction removal system comprises a mass configured to pivot about a fulcrum.

8. A rotor blade in accordance with claim 1, wherein said obstruction removal system comprises a cable coupled to an extension device.

9. A rotor blade in accordance with claim 1, wherein said obstruction removal system comprises a pin coupled to a motor.

10. An obstruction removal system for use in a wind turbine rotor blade having an opening defined in an end wall, said obstruction removal system comprising:
a movable component; and,
a pin coupled to said movable component, wherein said movable component is configured to position said pin in the opening to remove obstructions from the opening.

11. An obstruction removal system in accordance with claim 10, wherein said movable component is configured to operate by at least one of gravity and a centrifugal force generated by a rotation of the rotor blade.

12. An obstruction removal system in accordance with claim 10, further comprising a spring coupling said pin to said movable component to facilitate retracting said pin from the opening.

13. An obstruction removal system in accordance with claim 10, wherein a pitch axis is defined along a length of the rotor blade, the rotor blade further comprising a guide wall configured to limit a movement of said pin in a radial direction with respect to the pitch axis.

14. An obstruction removal system in accordance with claim 10, further comprising a mass configured to pivot said movable component about a fulcrum.

15. An obstruction removal system in accordance with claim 10, further comprising a cable coupled to said movable component, wherein said cable operates said movable component to position said pin in the opening.

16. A wind turbine, comprising:
a rotor blade configured to rotate about an axis, said rotor blade comprising a tip portion having an end wall including an opening defined therein; and,
an obstruction removal system positioned with respect to said rotor blade, said obstruction removal system configured to remove obstructions from the opening.

17. A wind turbine in accordance with claim 16, wherein said obstruction removal system is configured to operate by at least one of gravity and a centrifugal force generated by a rotation of said rotor blade.

18. A wind turbine in accordance with claim 16, wherein said obstruction removal system comprises a rotatable component and a pin, said rotatable component configured to position said pin in the opening to remove obstructions from the opening.

19. A wind turbine in accordance with claim 16, wherein said obstruction removal system comprises a mass configured to pivot about a fulcrum.

20. A wind turbine in accordance with claim 16, wherein said obstruction removal system comprises a cable coupled to an extension device.
